(19) United States
(12) Patent Application Publication
(10) Pub. No.: US 2018/0067701 A1
(43) Pub. Date: Mar. 8, 2018

(54) INFORMATION PROCESSING APPARATUS, CONTROL METHOD THEREFOR, AND STORAGE MEDIUM

(71) Applicant: CANON KABUSHIKI KAISHA, Tokyo (JP)

(72) Inventor: Kenichi Shirai, Ichikawa-shi (JP)

(21) Appl. No.: 15/679,623

(22) Filed: Aug. 17, 2017

(30) Foreign Application Priority Data
Sep. 7, 2016 (JP) 2016-174966

(51) Int. Cl. G06F 3/12; G06F 9/50

(52) U.S. Cl. CPC G06F 3/1204; G06F 9/5083; G06K 15/1801; G06F 3/1229; G06F 3/1293; G06F 3/1238

(57) ABSTRACT

By executing parallel processing while keeping a certain parallel number with respect to one user according to a status of processing for converting print data, an information processing apparatus controls the job order and monopolization of computing resources while effectively utilizing scalability of a cloud service.

### BACKGROUND OF THE INVENTION

### Field of the Invention

The present invention relates to an information processing apparatus, a control method therefor, a storage medium, and particularly to a parallel processing method in a printing system having a redundant configuration.

### Description of the Related Art

In recent years, a business in which a server is arranged on the Internet and the server provides a cloud service has been developed. Examples of such business include a storage service that stores data in a file format and a database service that provides a database function. With popularization of this cloud service, a pull print environment in which a printer acquires print data from a print server over the Internet and performs printing has been demanded. A main feature of such a cloud service is that data processing of document data is subjected to distributive execution using many computing resources on a cloud side, and requests from many clients are processed simultaneously. However, many computing resources generate a substantial cost, and therefore it is important to minimize the computing resources and to make efficient use of the computing resources. Japanese Patent Application Laid-Open No. 2010-204876 and Japanese Patent Application Laid-Open No. 2005-100381 determine an optimum load sharing method and the number of parallel execution according to the situation of resources, and discuss maximally utilizing the resources effectively.

### SUMMARY OF THE INVENTION

An information processing apparatus is capable of executing, in parallel, a plurality of conversion processing for converting document data into print data printable by a printer, and includes a determination unit configured to determine whether the number of the conversion processing being executed in parallel exceeds a predetermined number for each management unit according to a received conversion request, and a unit configured to cause conversion processing for document data related to the conversion request to wait on a queue in a case where the determination unit determines that the number of the conversion processing exceeds the predetermined number, and to start the conversion processing for the document data related to the conversion request in a case where the determination unit determines that the number of the conversion processing does not exceed the predetermined number.

Further features of the present invention will become apparent from the following description of exemplary embodiments with reference to the attached drawings.

### BRIEF DESCRIPTION OF THE DRAWINGS

FIG. 1 is a block diagram illustrating a network configuration.

FIG. 2A is a hardware block diagram of a print server.

FIG. 2B is a hardware block diagram of a print server.

FIG. 3 is a modular block diagram of a printing system.

FIG. 4A is a software block diagram of a print server.

FIG. 4B is a software block diagram of a printer.

FIG. 5 is a software block diagram of a printer.

FIG. 6 is a diagram illustrating data managed by a print server and a pull print application.

FIG. 7 is a diagram illustrating an example of an index file.

FIG. 8 is a conceptual diagram of a communication method of a pull print application.

FIG. 9A is a conversion instruction processing flow for print data at the time of receiving a print request.

FIG. 9B is a print job control flow at the time of receiving status change notification in the print data conversion processing.

FIG. 10A is a processing flow for granting a related job ID at the time of receiving a print request.

FIG. 10B is a processing flow for granting a related job ID at the time of receiving a print request.

FIG. 11 is a diagram illustrating data managed by a print server.

FIG. 12 is a processing sequence diagram illustrating a specific example of a first exemplary embodiment.

### DESCRIPTION OF THE EMBODIMENTS

In a cloud service, all clients (tenants) share computing resources. Therefore, in a case where a certain client makes processing requests in a large amount and the maximum amount of resources are allocated to the client, processing for other clients is delayed, or worse, stops disadvantageously.

Meanwhile, for example, in a case where a specific client requests generation processing of a plurality of print jobs, such generation of a plurality of print jobs can be executed in parallel by consuming a lot of resources as described above. This makes it possible to generate a plurality of jobs in a short time. However, in a case where the order of processing a generated print job is determined, for example, when outputting from a specific printer, it is enough that a print job to be processed immediately after completion of processing of a certain print job, is generated before the completion. That is, in such a case, a printer can process a print job without taking a vacant time while parallel processing with a high degree of parallelism that consumes a large amount of resources is not performed. In such a way, a large amount of resources could be consumed due to unnecessary parallel processing.

The present embodiment is directed to suppressing resources consumed due to unnecessary parallel processing while generation processing of print data is parallelized.

Hereinafter, exemplary embodiments will be described with reference to the drawings.

### (Network Configuration)

Hereinafter, a first exemplary embodiment will be described.

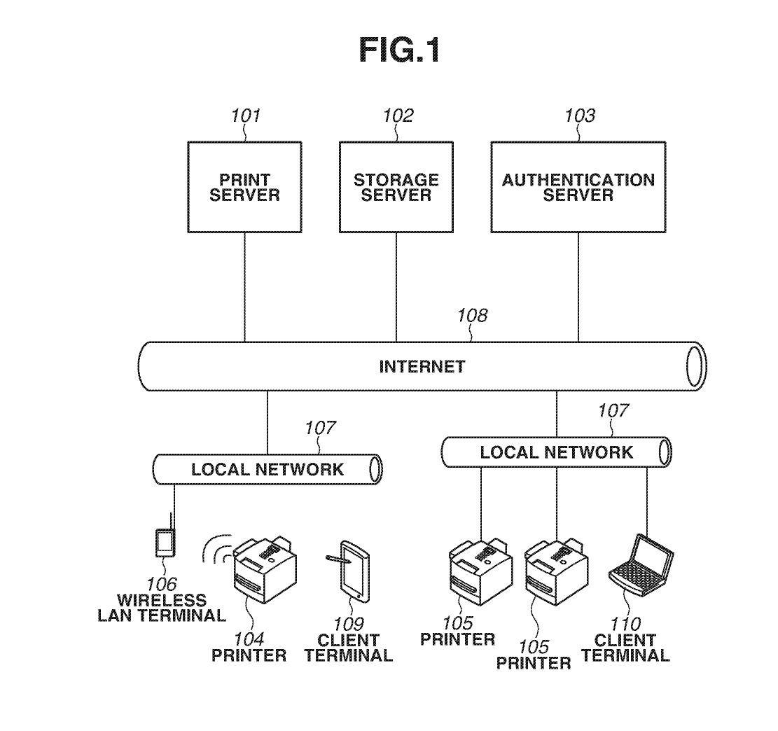

FIG. 1 is a diagram illustrating a network configuration of a printing system according to an exemplary embodiment. In FIG. 1, it is assumed that a plurality of printers 104 and 105 and a plurality of client terminals 109 and 110 are connected via a local network 107. The printers 104 and 105 and the client terminals 109 and 110 can access the Internet 108 via the local network 107, and can access a print server 101, a storage server 102, and an authentication server 103. The printers 104 and 105 and the client terminals 109 and 110 are connected to a network via a wired or wireless local area network (LAN). In the present exemplary embodiment, it is assumed that the printer 104 and the client terminal 109 are connected to a network via a wireless LAN terminal 106. The wireless LAN terminal 106 is a master device of a wireless LAN having a general network/router function, and provides a wireless LAN within a home or an office. For example, the networks 107 and 108 are any one of a LAN such as the Internet, a wide area network (WAN), a telephone line, a dedicated digital line, an asynchronous transfer mode (ATM) line, a frame relay line, a cable television line, and a data broadcasting wireless line. The networks 107 and 108 are so-called communication networks realized by a combination thereof. The networks 107 and 108 only need to be able to transmit and receive data. A communication unit from the client terminals 109 to 110 to the print server 101 and the printers 104 and 105 may be different from a communication unit from the printers 104 and 105 to the print server 101, the storage server 102, and the authentication server 103.

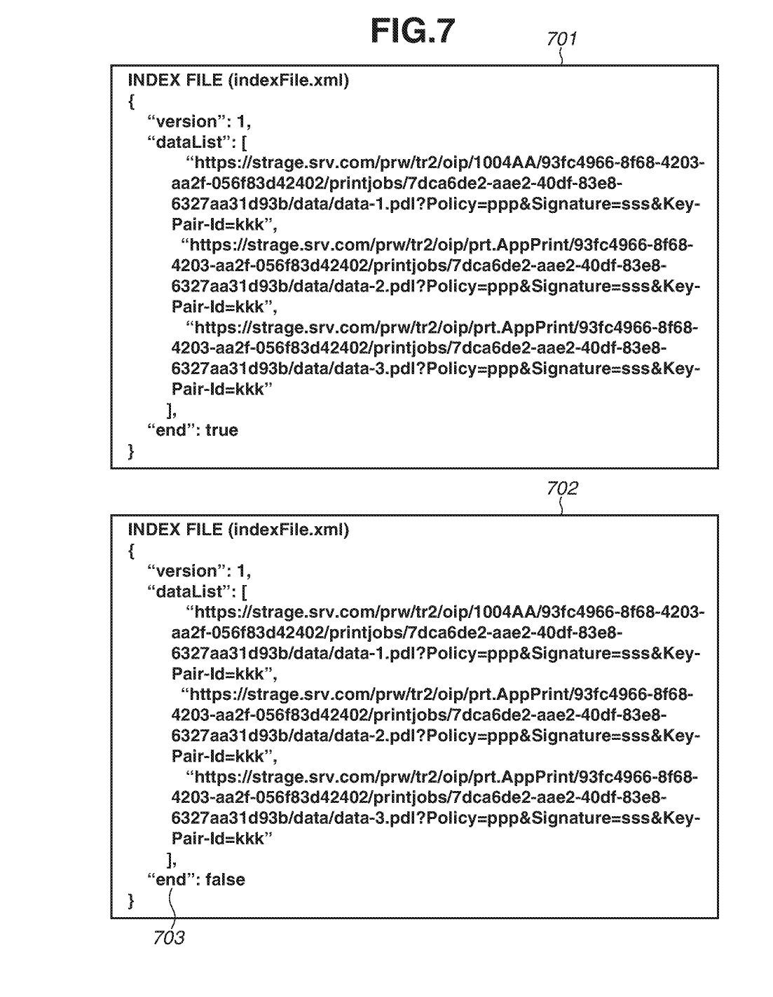

Each of the client terminals 109 to 110 is, for example, a desktop personal computer, a notebook personal computer, a mobile personal computer, or a personal digital assistant (PDA), but may be a cellular phone having a built-in program executable environment. Each of the client terminals 109 to 110 has a built-in program executable environment such as a web browser (an Internet browser, a world wide web (WWW) browser, or a browser used for the WWW). The print server 101 receives information for identifying a document to be printed and information for identifying the output destination printers 104 and 105 from web browsers of the client terminals 109 to 110 together with a print request. Then, the print server 101 returns a response including a command to execute a print instruction to the web browsers of the client terminals 109 to 110. The web browsers of the client terminals 109 to 110 issue a received print command to designated printers 104 and 105. Upon receiving the print command from the web browsers of the client terminals 109 to 110, the printers 104 and 105 acquire an index file (refer to index files 701 and 702 in FIG. 7) describing a uniform resource locator (URL) of the storage server 102, described below. The printers 104 and 105 access the URLs described in the index files 701 and 702, acquire print data from the storage server 102, and perform printing.

### (Hardware Configuration of Print Server)

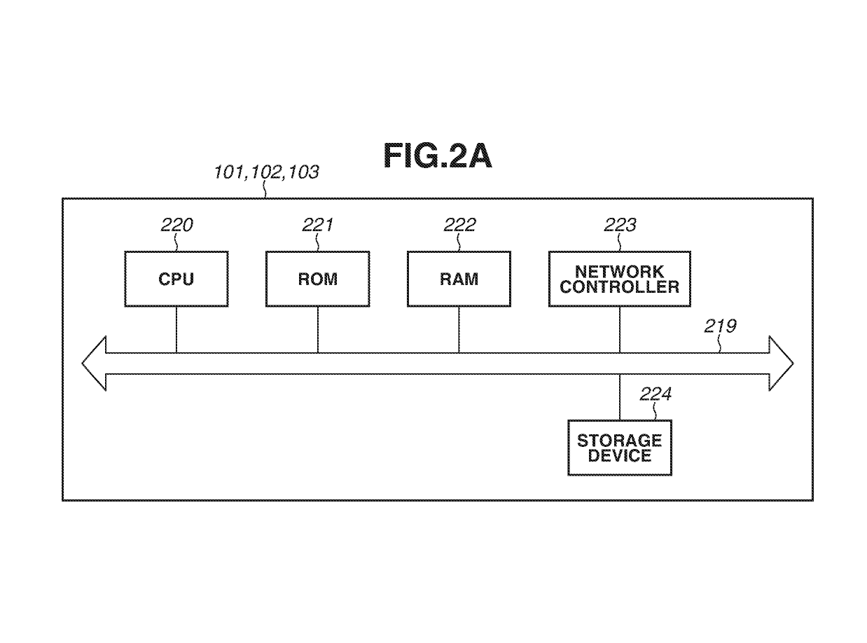

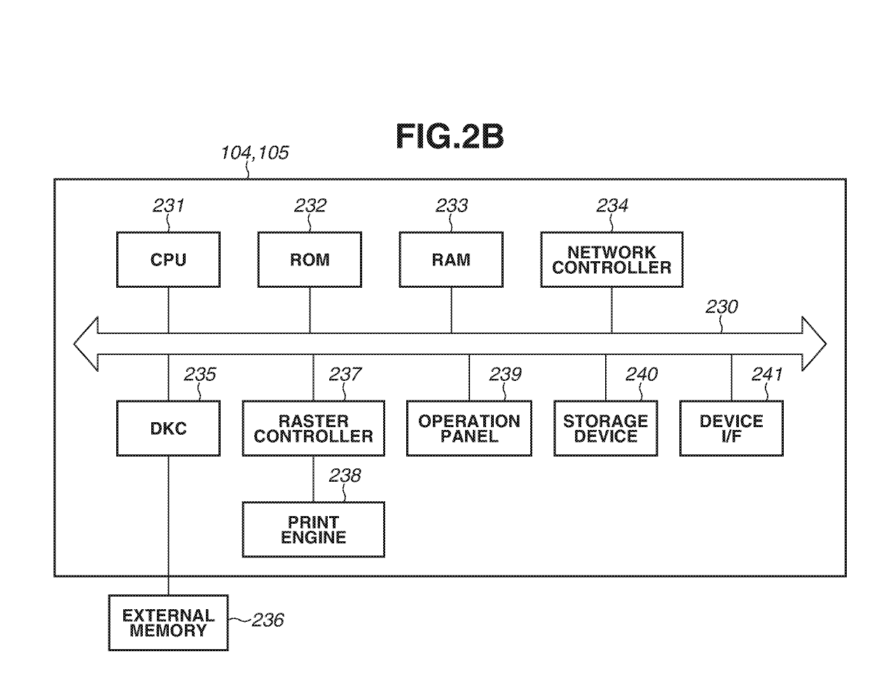

FIG. 2A is a diagram illustrating an example of a hardware configuration of the print server 101, the storage server 102, and the authentication server 103. Unless otherwise specified, the embodiments can be applied to a single device or a system composed of a plurality of devices as long as the functions of the embodiments are executable. In addition, unless otherwise specified, embodiments can be applied even to a system in which a connection is made via a network such as LAN or WAN and processing is performed as long as the functions of the embodiments are executable. In the present exemplary embodiment, description will be given assuming that components are connected to each other with a system bus 219.

A central processing unit (CPU) 220 is a control device of an information processing apparatus, and executes an application program, an operating system (OS), and the like of a print server stored in a storage device 224. In addition, the CPU 220 performs control to temporarily store information, a file, and the like necessary for program execution in a random access memory (RAM) 222. In addition, the CPU 220 executes conversion processing into print data in a print server program, and the like. A read only memory (ROM) 221 is a storage unit, and internally stores a program such as a basic input/output (I/O) program, font data used for data conversion into print data, and various data necessary for print processing and data conversion processing. The RAM 222 is a temporary storage unit, and functions as a main memory, a work area, or the like of the CPU 220. The storage device 224 is one of external storage units, functions as a large volume memory, and stores an application program, an OS, and the like. A network controller 223 is, for example, a network interface card (NIC), and a server exchanges data with an external device via the network controller 223.

### (Hardware Configuration of Printer)

FIG. 2B is a hardware block diagram of each of the printers 104 and 105. In this block diagram, a portion excluding a print engine 238 may be referred to as a controller that governs a control system of a printer. Components of hardware are connected to a system bus 230.

A CPU 231 controls the entire apparatus, and comprehensively controls access to various devices connected to the system bus 230. This control is based on a control program or the like stored in the ROM 232, or a control program, resource data (resource information), or the like stored in an external memory 236 connected via a disk controller (DKC) 235. The RAM 233 functions as a main memory, a work area, or the like of the CPU 231, and is configured such that a memory capacity can be expanded by an option RAM connected to an expansion port (not illustrated). The storage device 240 is an external storage unit that functions as a large volume memory. An operation panel (operation unit) 239 displays a screen, and accepts an operation instruction of a user via the screen. In addition, buttons for performing an operation such as setting operation modes or the like of the printers 104 and 105, displaying operation conditions of the printers 104 and 105, or designating content data to be printed, and a display unit such as a liquid crystal panel are also arranged. A network controller 234 is, for example, an NIC, and exchanges data with an external device via the network controller 234. A raster controller 237 is, for example, a controller that converts print data described in page description language (PDL) into image data. The print engine 238 forms an image on a sheet based on the image data input from the raster controller 237 using a known printing technique. Examples of a preferable execution system include a print engine employing an electrophotographic method (laser beam method), an ink jet method, a sublimation (thermal transfer) method or the like. A device interface (I/F) 241 is a connection I/F to an external apparatus connectable by a universal serial bus (USB) or the like.

### (System Configuration)

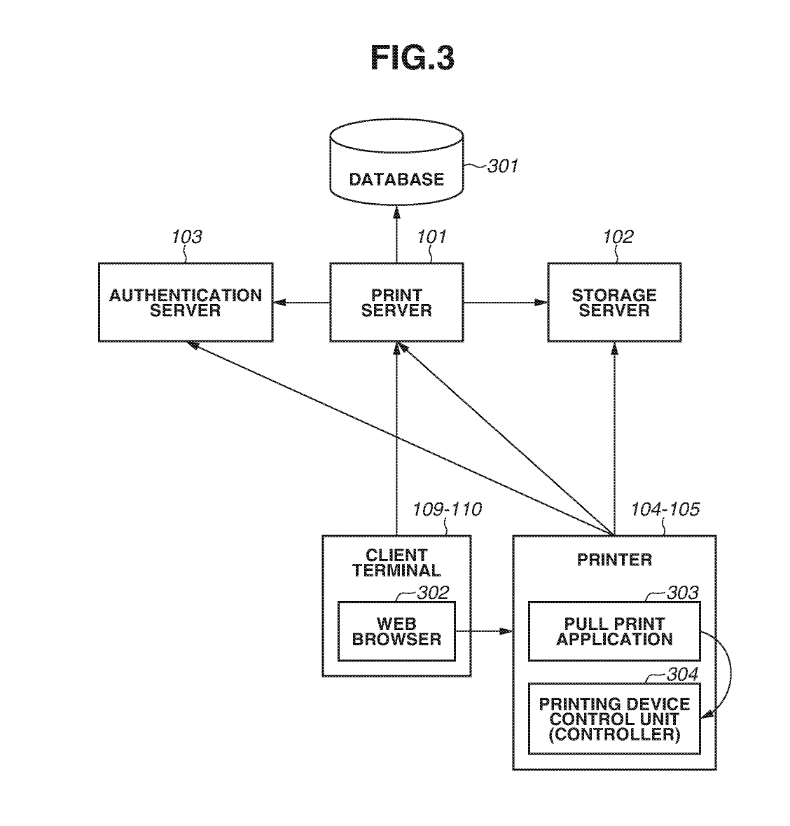

FIG. 3 is a block diagram of a printing system according to an exemplary embodiment. Here, operations of a server, a printer, and a client terminal will be described using the block diagram of the printing system. These operations are realized by execution of a program stored in a memory of each device by the CPU.

The print server 101 creates a URL indicating an input destination of document data input by another service or another program, and returns the URL to the other service or the other program which has input the document data. In the present exemplary embodiment, the URL returned by the print server 101 is a URL indicating an upload destination of the document data to the storage server 102. The other service or the other program uploads, on the URL, document data of a print target identified in response to receiving a print instruction from a user. Upon receiving information indicating that the document data has been uploaded from the other service or the other program, the print server 101 stores document information 620 of the input document data in a database 301. Upon receiving a print request from a web browser 302, the print server 101 acquires, from the storage server 102, document data associated with a document ID 621 received together with the print request, and converts the document data into print data based on the acquired document data. For example, by inclusion of a document ID in document information, it is possible to identify the document information including the document ID, and to identify document data associated with the document information. The print server 101 creates print data, and creates a download URL on the storage server 102. The print server 101 describes the download URL in the index files 701 and 702, uploads the print data to the download URL, and uploads the index files 701 and 702 to the storage server 102.

The authentication server 103 holds authentication information such as a user name, a password, an authentication token, or an authorization token to access the print server 101. The print server 101 sends an authentication token included in a request from the web browser 302 in the client terminals 109 and 110 to the authentication server 103 to verify validity of the token. At this time, in a case where the authentication token is not present in the request from the web browser 302, the print server 101 causes the authentication server 103 to redirect the request. Then, the authentication server 103 returns a login screen 500 to the web browser 302. The authentication server 103 verifies validity by comparing a user name and a password included in a login request from the login screen 500 displayed on the web browser 302 with a user name and a password held by the authentication server 103. When the verification is successful, the authentication server 103 issues an authentication token associated with a user, and sends a response to perform a redirection to the print server 101 to the web browser 302 together with the token.

The web browser 302 sends a request including the authentication token to the print server 101, and receives and displays web screens 510, 520, and 530 by a response from the print server 101.

The authentication server 103 issues an authorization token necessary for a pull print application 303 to be installed in the printers 104 and 105 to access the print server 101. In addition, the authentication server 103 verifies validity of the authorization token included in a request in a case where the pull print application 303 accesses the print server 101.

The pull print application 303 sends the request including the authorization token to the print server 101, and in response to the request, acquires the index files 701 and 702 describing the URL indicating the print data. The pull print application 303 acquires print data from the storage server 102 according to the URL indicating the print data, sends the print data to a printing device control unit 304, and performs printing.

### (Software Configuration of Print Server)

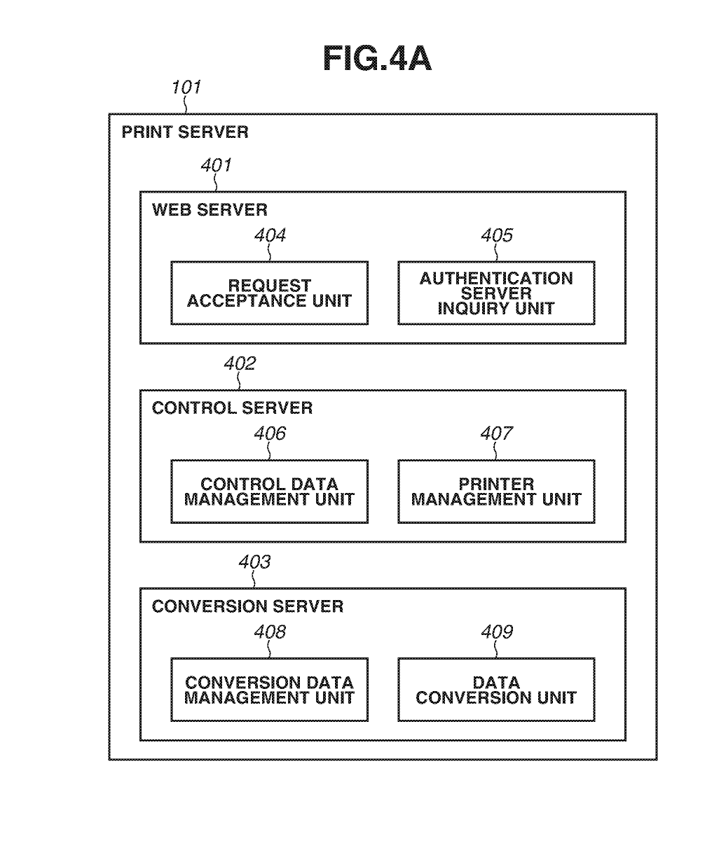

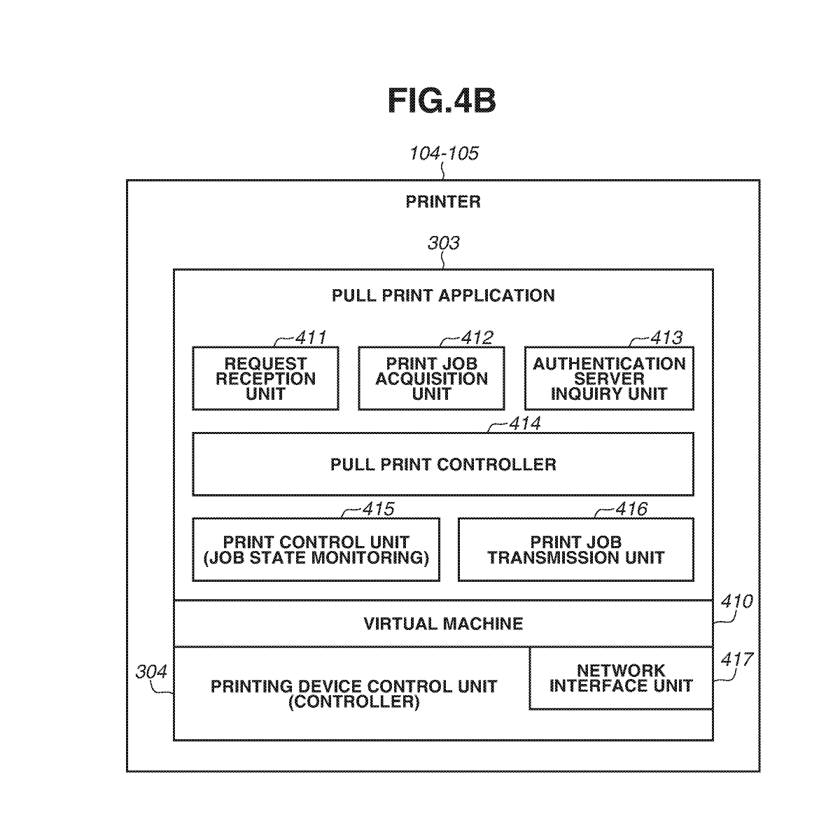

FIG. 4A is a software block diagram of the print server 101 according to an exemplary. Each software module of the print server 101 is stored in the storage device 224 illustrated in FIG. 2A, loaded in the RAM 222 by the CPU 220, and executed as described above. Here, an operation of each software module of the print server 101 when the print server 101 receives an external request will be described.

The print server 101 includes a web server 401 that accepts an external request, a control server 402 that manages document data, a print job, and printer information, and controls print processing, and a conversion server 403 that converts document data into print data. These are independent programs and can be arranged in separate information processing apparatuses. Each of these programs is arranged in an information processing apparatus connected to a network, and communication is performed between the programs. In addition, as a communication method between the programs, a method with a service to mediate communication between the programs such as a message queue service is also considerable. It is also possible to arrange these programs in the same information processing apparatus. In addition, each server is arranged so as to have a single unit configuration or a redundant configuration. Therefore, one server may include a plurality of information processing apparatuses. In addition, cloud computing is assumed, and each server has a configuration that can automatically increase or decrease the number of servers (auto scale technology) according to a processing load and failure occurrence. For example, threshold values of the number of accesses, the number of requests present in a message queue service, and a CPU usage ratio are registered in advance in a management function provided by cloud computing with respect to the conversion server 403, and only the number of the conversion servers 403 can be increased or decreased automatically depending on a situation.

The web server 401 receives input of document data, a print request, and a print data request from another service or another program, the printers 104 and 105, or the web browser 302. When a request acceptance unit 404 receives a request from each client, an authentication server inquiry unit 405 sends a token validity verification request to the authentication server 103. When the validity of the token is confirmed, the request acceptance unit 404 sends a request from a client to the control server 402.

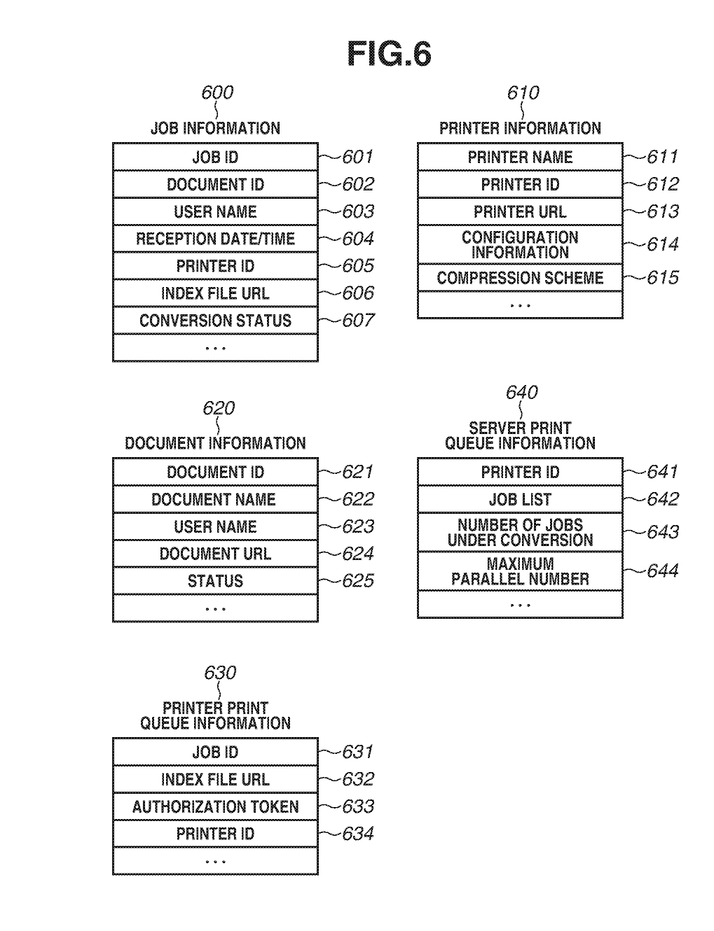

Upon receiving a document data input request, the control server 402 creates document information 620 a configuration of which is illustrated in FIG. 6 in a control data management unit 406, and stores the document information 620 in the database 301. As illustrated in FIG. 6, the document information 620 includes the document ID 621 for identifying document data, a document name 622, a user name 623 associated with an authentication token, a document URL 624 for uploading a document to the storage server 102, and a status 625. The document URL 624 includes the document ID 621. The status 625 includes statuses of “receiving”, “idling”, “waiting for printing”, “printing”, “normal end”, “error end”, and “unknown end”. The control server 402 changes the status 625 of the document information 602 to “receiving” and returns the document URL 624 to the web server 401. Then, the web server 401 returns the document URL 624 to another service or another program as a request source. Upon completing uploading of document data to the storage server 102, another service or another program sends an upload completion notification to the print server 101. When the print server 101 receives this notification on the web server 401, the control server 402 changes the status 625 of the document information 602 to “idling”.

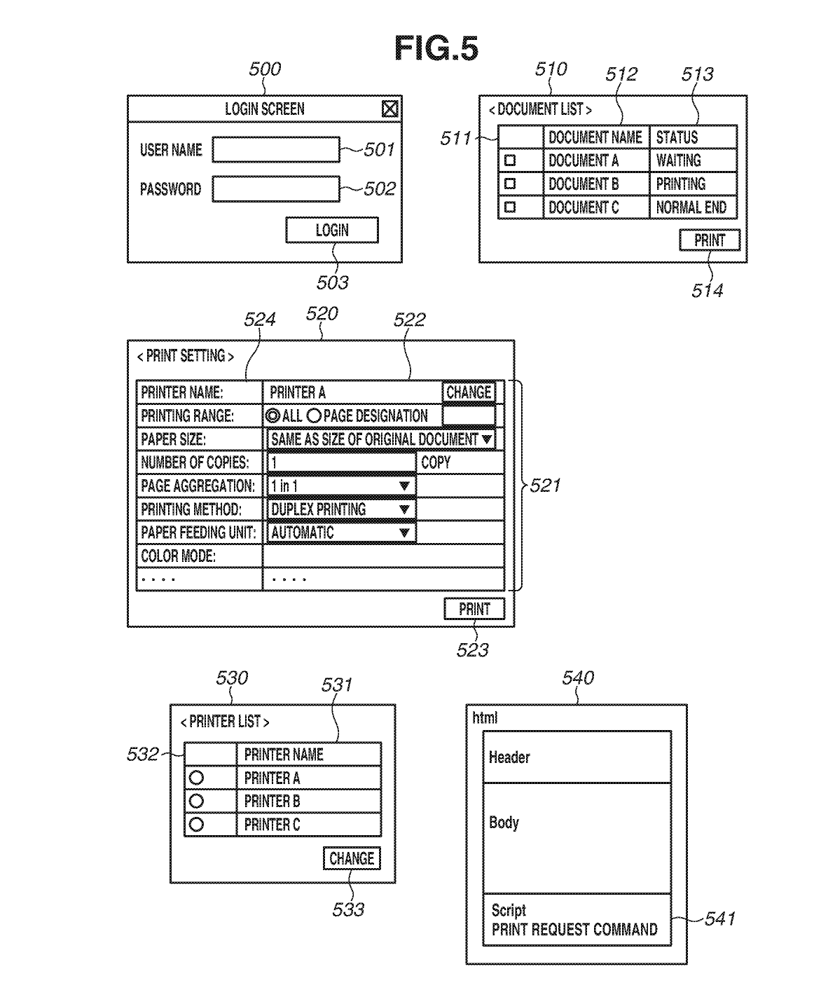

When the control server 402 receives a print request, the control data management unit 406 creates job information 600 illustrated in FIG. 6 for the print request, and stores the job information 600 in the database 301. The print request includes the document ID 621 to be printed and a printer ID 612. This document ID 621 is the document ID 621 associated with the document name 622 of the document information 620 corresponding to a document name 512 on the document list screen 510 illustrated in FIG. 5, displayed as a document of a print target by the web browser 302. The printer ID 612 is the printer ID 612 associated with a printer name 611 of printer information 610 (refer to FIG. 6) corresponding to a printer name 524 on the print setting screen 520 illustrated in FIG. 5, displayed by the web browser 302. The job information 600 created by the control data management unit 406, illustrated in FIG. 6, includes a job ID 601 for identifying a print job, the document ID 602 corresponding to the document ID 621 of the document information 620, a user name 603 associated with an authentication token, a print reception date/time 604, a printer ID 605 corresponding to the printer ID 612 of the printer information 610, an index file URL 606, and a conversion status 607.

In addition, the control data management unit 406 includes server print queue information 640 illustrated in FIG. 6 for each printer ID 612. The control data management unit 406 adds the job ID 601 to a job list 642 of the server print queue information 640 identified from the printer ID 612 included in the print request when receiving the print request. The control server 402 controls a conversion instruction into print data according to the server print queue information 640 and the number of jobs under conversion 643. Details of print data conversion instruction processing will be described below. The server print queue information 640 includes the printer ID 612, the job list 642, the number of jobs under conversion 643, and a maximum parallel number 644. The number of jobs 643 under conversion indicates the number requested to the conversion server 403 among the jobs included in the job list 642. The number of jobs 643 under conversion is controlled by the control data management unit 406, added at the time of making a request to the conversion server 403, and subtracted when processing of the conversion server 403 is completed. The maximum parallel number 644 is the maximum value at which a conversion instruction is made in parallel to the conversion server 403. In the present exemplary embodiment, the maximum parallel number 644 will be described as information preset for each server print queue information 640. However, the maximum parallel number 644 may be a single value in a system or a value that automatically varies depending on an engine speed of a printer.

The control data management unit 406 acquires the printer information 610 corresponding to the printer ID 612 from the printer management unit 407, passes configuration information 614, a compression scheme 615, the document URL 624, and the job ID 601 to the conversion server 403, and instructs conversion into print data. As illustrated in FIG. 6, the printer information 610 managed by the printer management unit 407 includes the printer name 611, the printer ID 612 for identifying a printer, a printer URL 613 for the web browser 302 to send a print request to the printers 104 and 105, the configuration information 614, and the compression scheme 615 indicating a compression scheme that can handle print data. In addition, the configuration information 614 indicates functions of the printers 104 and 105 that can determine whether an item of a print property 521 of the print setting screen 520 functions. Examples thereof include a double-sided function and a color function. The control server 402 returns, to the web browser 302, a screen 540 including the printer URL 613, the job ID 601, and the printer ID 605 as a print request command in a script via the web server 401. The web browser 302 sends a print request to the pull print application 303 of each of the printers 104 and 105 according to the script of the screen 540. When the print request is successful to the pull print application 303, the web browser 302 notifies the print server 101 thereof. Upon receiving the notification via the web server 401, the control data management unit 406 changes the status 625 of the document information 620 to “waiting for printing”.

Upon receiving a print data conversion instruction (or conversion request) from the control server 402, a conversion data management unit 408 of the conversion server 403 downloads document data from the document URL 624 of the storage server 102. Then, a data conversion unit 409 converts the document data into print data while taking the configuration information 614 into account. The data conversion unit 409 creates a plurality of print data in a file format according to a conversion data size. Note that print data in a file format is referred to as a print data file, but data referred to as print data means all types of print data including a file format. When the data conversion unit 409 creates a certain number of print data files, the conversion data management unit 408 creates print data file URLs on the storage server 102 corresponding to the number of generated print data files, and creates the index files 701 and 702 describing the URLs. Then, the conversion data management unit 408 creates the index file URL 606 on the storage server 102, and uploads the index files 701 and 702 and the plurality of print data files to the URLs thereof. At this time, the conversion data management unit 408 converts the data format into a data format according to the compression scheme 615, and uploads the print data file to the storage server 102. At this time, an end flag 703 is added to each of the index files 701 and 702. For example, when the print data file is being created, the conversion data management unit 408 sets false as the end flag 703 as in the index file 702. On the other hand, when creation of the print data file is completed, the conversion data management unit 408 sets true as the end flag 703 as in the index file 701. The conversion data management unit 408 sends the index file URL 606 to the control server 402. In the present exemplary embodiment, the conversion data management unit 408 notifies the control server 402 when the status of the print data conversion processing changes, and the control server 402 updates the conversion status 607. Specifically, the conversion data management unit 408 notifies the control server 402 of conversion start, conversion completion, and conversion error. An initial value of the conversion status 607 is unprocessed. A status in which the conversion data management unit 408 uploads an index file to the storage server 102 is the conversion start, a status in which creation of all the print data files is completed is the conversion completion, and a status in which creation of the print data file fails due to some faults is the conversion error. The control server 402 registers the index file URL 606 in the job information 600 of the database 301. Upon completion of creation of the remaining print data files included in the print job, the data conversion unit 409 generates a print data file URL at any time, and creates the index files 701 and 702 describing the generated URL. A print data file is uploaded to a URL generated at any time while the index files 701 and 702 are uploaded to the already created index file URL 606.

### (Web Screen)

FIG. 5 is a web screen created by the web server 401 of the print server 101 according to the exemplary embodiment and displayed by the web browser 302 of the client terminals 109 to 110.

When the web browser 302 sends a document list request to the print server 101, the print server 101 creates a document list screen 510 and transmits the document list screen 510 to the web browser 302. The document list screen 510 includes a document selection check box 511, the document name 512, a status 513, and a print button 514. The status 513 is the status 625 of the document information 620. The print server 101 creates a screen with the status 625 at the time of receiving the document list request as the status 513 of the document list screen. The document selection check box 511 is a check box for selecting a document to be printed, and one or more checks may be made. Upon detecting that the print button 514 is pressed, the web browser 302 transmits, to the print server 101, a document list in which the document selection check box 511 is selected.

Upon accepting the document list, the print server 101 creates a print setting screen 520 and transmits the print setting screen 520 to the web browser 302. The print setting screen 520 is a setting screen of a print property 521. The printer name 524 corresponds to a printer that performs printing. Upon detecting that the change button 522 is pressed, the web browser 302 makes a request to the print server 101.

Upon accepting the document list, the print server 101 creates a print setting screen 520 and transmits the print setting screen 520 to the web browser 302. The print setting screen 520 is a setting screen of the print property 521. The printer name 524 corresponds to a printer that performs printing. Upon detecting that the change button 522 is pressed, the web browser 302 makes a request to the print server 101.

Upon receiving the request, the print server 101 creates a printer list screen 530 from the printer information 610, and transmits the printer list screen 530 to the web browser 302. The printer list screen 530 includes a printer selection radio button 531, a printer name 532, and a change button 533. Upon detecting that the change button 533 is pressed, the web browser 302 transmits, to the print server 101, printer information in which the radio button 531 is selected. The print server 101 updates the printer name 524 of the print setting screen 520 to a name of a printer for which the radio button 531 has been selected, and transmits the print setting screen 520 to the web browser 302.

Upon detecting that a print button 523 is pressed on the print setting screen 520, the web browser 302 transmits the print property 521, the printer name 524, and a document list in which the document selection check box 511 has been selected on the document list screen 510 to the print server 101. The web browser 302 thereby makes a print request to the print server 101. Here, the print setting screen 520 holds the document list in which the document selection check box 511 has been selected on the document list screen 510, on the screen as a hidden parameter.

Upon detecting that the print button 523 is pressed on the print setting screen 520, the web browser 302 transmits the print property 521, the printer name 524, and a document list in which the document selection check box 511 has been selected on the document list screen 510 to the print server 101. The web browser 302 thereby makes a print request to the print server 101. Here, the print setting screen 520 holds the document list in which the document selection check box 511 has been selected on the document list screen 510, on the screen as a hidden parameter.

### (Software Configuration of Printer)

FIG. 4B is a software block diagram of each of the printers 104 and 105 according to an exemplary embodiment. Note that software modules of the printers 104 and 105 are stored in the storage device 240 in FIG. 2B, and are loaded to the RAM 233 and executed by the CPU 231 as described above. Here, operations of the software modules of the printers 104 and 105 when the printers 104 and 105 receive an external request will be described.

### (Acquisition of Print Job by Pull Print Application)

The pull print application 303 is application software operated on a virtual machine 410. A pull print controller 414 of the pull print application 303 manages an operation of the entire pull print application 303, and an operation instruction or the like to each part is performed via the pull print controller 414. Upon receiving a print request from the web browser 302, a request reception unit 411 of the pull print application 303 notifies the print job acquisition unit 412 of print request information. The print request information includes the job ID 601 and the printer ID 605. The print job acquisition unit 412 manages acquisition of print data with printer print queue information 630 illustrated in FIG. 6. The printer print queue information 630 is queue information of print job information such as a job ID 631, an index file URL 632, an authorization token 633, or a printer ID 634. The job ID 601 and the printer ID 605 sent from the web browser 302 are held in the job ID 631 and the printer ID 634 of the printer print queue information 630. Then, the print job acquisition unit 412 makes a request for issuing an authorization token to an authentication server inquiry unit 413. The authentication server inquiry unit 413 makes a request for issuing an authorization token to the authentication server 103. At this time, the authentication server inquiry unit 413 sends, to the authentication server 103, a certificate certified by the authentication server 103 registered in advance. When the authentication server 103 verifies the certificate and can confirm validation thereof, the authentication server 103 issues an authorization token, and sends the authorization token to the authentication server inquiry unit 413. The authentication server inquiry unit 413 sends the authorization token to the print job acquisition unit 412, and the print job acquisition unit 412 holds the authorization token in the authorization token 633 of the printer print queue information 630.

The print job acquisition unit 412 of the pull print application 303 sends, to the print server 101, an index file URL request for the job ID 631 at the head of the printer print queue information 630. At this time, the print job acquisition unit 412 sends an index file URL request including the job ID 631, the printer ID 634, and the authorization token 633. The print server 101 identifies the index file URL 606 of the print job from the job information 600 including the received job ID 631, the job ID 601 corresponding to the printer ID 634, and the printer ID 605. Then, the print server 101 returns the identified index file URL 606 to the pull print application 303. The print job acquisition unit 412 holds the received index file URL 606 in the index file URL 632 of the printer print queue information 630. Then, the print job acquisition unit 412 accesses the storage server 102 with the index file URL 632, and acquires the index file 701 illustrated in FIG. 7. The print job acquisition unit 412 acquires print data files corresponding to described URLs from print data file URLs on the storage server 102 described in the index file 701. At this time, a case where the end flag 703 of each of the index files 701 and 702 in FIG. 7 is false indicates that the conversion processing on the print server 101 is in progress and that a print data file URL may be further added. In this case, the print job acquisition unit 412 again acquires the index file URL 632 from the storage server 102 as soon as the acquisition processing of the print data file corresponding to the URL describing the print data file is completed. A case where the end flag 703 is true means that all the print data has been acquired, and a print job transmission unit 416 described below closes a printer communication stream 802 described below.

### (Transmission of Print Job by Pull Print Application)

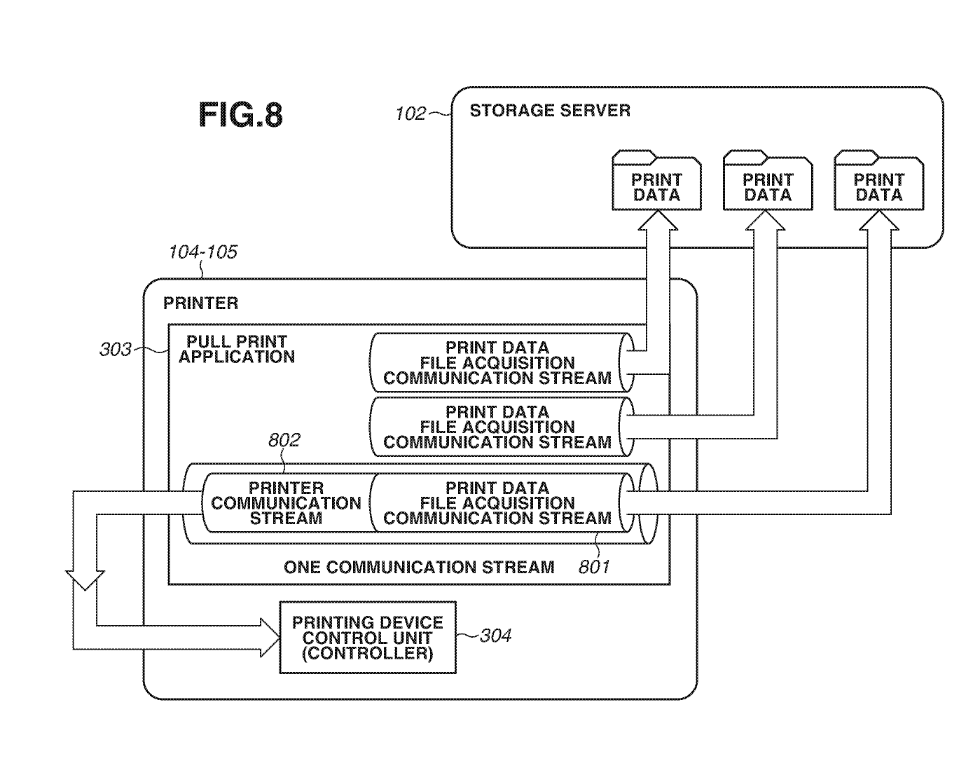

The print job transmission unit 416 receives print data sent from the print job acquisition unit 412, and holds the print data in a transmission buffer stream. Then, the print job transmission unit 416 transmits the print data stored in the transmission buffer stream to the printing device control unit 304 via a network interface unit 417. The print job transmission unit 416 stores print data in the transmission buffer stream, but transmits the print data to the printing device control unit 304 while receiving the print data from the storage server 102. Therefore, only a part of the print data is stored in the buffer stream. This is because the printing device control unit 304 manages one print job unit with one communication connection to the network interface unit 417. That is, to perform first print early, the print job transmission unit 416 needs to transmit a print job to the printing device control unit 304 with one communication connection while receiving a print data file divided into a plurality of portions in the storage server 102. Here, this mechanism will be described with reference to FIG. 8.

FIG. 8 is a conceptual diagram in which the print job transmission unit 416 sends print data to the printing device control unit 304 with one communication connection while the print job acquisition unit 412 acquires a plurality of print data files from the storage server 102. First, to start print processing of the printers 104 and 105 early, the print server 101 creates one print data file including converted data as soon as print data conversion is completed, and uploads the print data file to the storage server 102. By sending the print data to the printing device control unit 304 early, preprocessing of the print engine 238 that takes a long time can be started early, and as a whole, first print of the printers 104 and 105 is performed early. However, as described above, the print job transmission unit 416 needs to transmit a print job to the printing device control unit 304 with one communication connection. Therefore, the pull print controller 414 maintains a print data file acquisition communication stream 801 and the printer communication stream 802 as one communication stream. The print data file acquisition communication stream 801 is communication between the print job acquisition unit 412 and the storage server 102. The printer communication stream 802 is communication between the print job transmission unit 416 and the network interface unit 417 of the printing device control unit 304. When the print job acquisition unit 412 acquires the second and subsequent print data files, the following processing is performed. The pull print controller 414 connects the print data file acquisition communication stream 801 newly created by the print job acquisition unit 412 to the existing printer communication stream 802, and maintains these communication streams as one communication stream. This makes it possible to print a print data file divided into a plurality of portions as one print job while performing first print early. Here, the print data file acquisition communication stream 801 is communication via the Internet, and uses Hyper Test Transfer Protocol Secure (HTTPS) as a communication protocol. On the other hand, the printer communication stream 802 is communication in a local network from the printers 104 and 105 to different ports, and uses a RAW protocol as a communication protocol.

An operation of each software module of the printers 104 and 105 when the printers 104 and 105 receive an external request has been described above.

(Conversion Instruction Processing Flow at the time of Print Request)

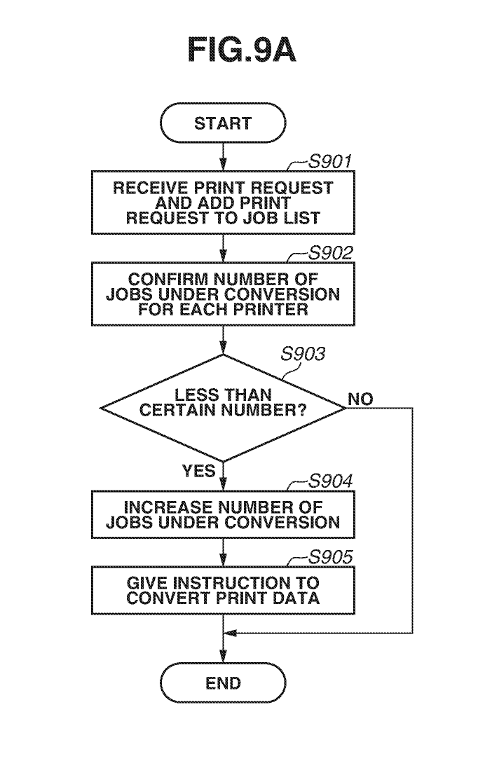

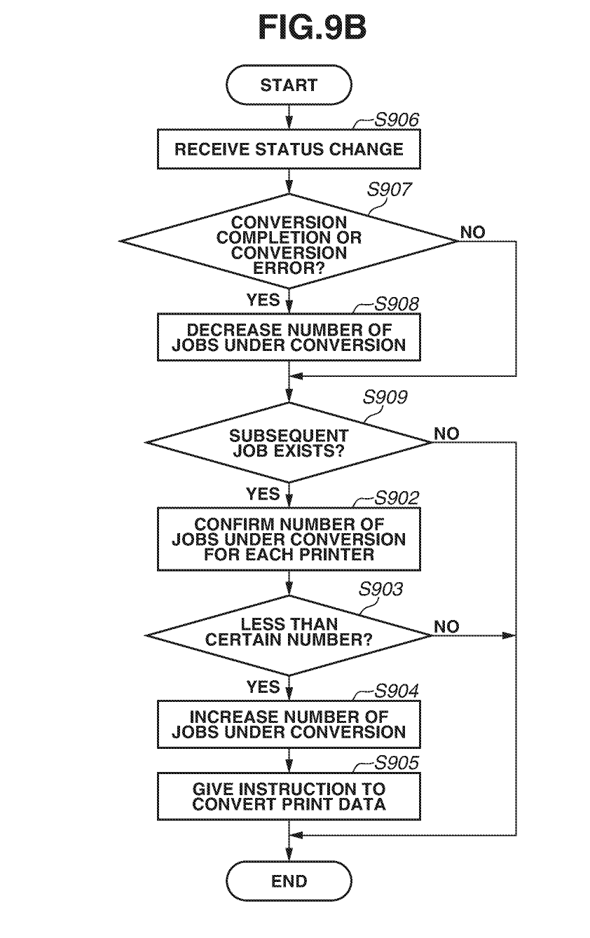

FIG. 9A is a print data conversion instruction processing flow at the time of receiving a print request by the control server 402 of the print server 101 according to an exemplary embodiment. As described above, in the present exemplary embodiment, the print server 101 has a configuration capable of performing auto scale. That is, the number of servers having a redundant configuration varies depending on the situation of each server. In particular, the conversion server 403 in the present exemplary embodiment has a configuration of maintaining an optimum configuration number at all times to maintain constant performance in request response and conversion processing. The procedure in FIG. 9A is realized by executing a program stored in the RAM 222 by the CPU 220 of the print server 101, for example.

In step S901, the print server 101 receives a print request from the web browser 302 arranged in each of the client terminals 109 and 110. At this time, the control server 402 of the print server 101 creates the job information 600, and holds the job information 600 in the database 301. In addition, the control server 402 adds the job ID 601 to the job list 642 of the server print queue information 640 identified from the printer ID 612 included in the print request. In step S902, the control server 402 acquires the number of jobs under conversion 643 of the server print queue information 640 identified by the printer ID 612 included in the print request received in step S901. In step S903, the control server 402 compares the number of jobs under conversion 643 acquired in step S902 with the predetermined maximum parallel number 644 of the server print queue information 640. Here, the number of jobs under conversion for each predetermined management unit (for each user in the present exemplary embodiment) is compared with a threshold value. As a result of the comparison in step S903, if the number of jobs under conversion 643 is smaller than the maximum parallel number 644 (YES in step S903), in step S904, the control server 402 updates the number of jobs under conversion 643 with a value obtained by adding 1 to the number of jobs under conversion 643 acquired in step S902. That is, the number of jobs under conversion is increased by one. In step S905, the control server 402 instructs the conversion server 403 to convert the print data of the job ID 601. As a result of the comparison in step S903, if the number of jobs under conversion 643 is equal to or more than the maximum parallel number 644 (NO in step S903), nothing is performed, and the processing ends. In the present exemplary embodiment, priority is given to redundancy of each server, and the number of jobs under conversion 643 is allowed to temporarily exceed the maximum parallel number depending on the timing of notification from the conversion server 403 and the timing of acquiring information from the database 301. Naturally, it is also considered to perform exclusion processing so as not to exceed the maximum parallel number.

As described above, the control server 402 performs processing so as not to exceed a certain parallel number for one management unit, for example, for one user, at all times without being conscious of availability of the conversion server 403 or the configuration number. The management unit is not limited to a user, but may be another item.

Through the above processing, even when the conversion server 403 can process print data conversion in parallel, the conversion server 403 can perform print data conversion processing while suppressing occupation of resources.

(Print Job Control Flow at the time of Receiving Status Change Notification of Print Data Conversion Processing)

FIG. 9B is a print job control flow at the time of receiving status change notification of print data conversion processing by the conversion server 403 of the print server 101 according to an exemplary. The procedure in FIG. 9B is realized by executing a program stored in the RAM 222 by the CPU 220 of the print server 101, for example.

In step S906, the control server 402 receives a status change of the print data conversion processing from the conversion server 403, and updates the conversion status 607 of the job information 600. In step S907, if the conversion status 607 updated in step S906 is in a state of conversion completion or conversion error (YES in step S907), in step S908, the control server 402 updates the number of jobs under conversion 643 with a value obtained by subtracting 1 from the number of jobs under conversion 643 acquired in step S902. That is, the number of jobs under conversion is decreased by 1. In step S909, the control server 402 confirms whether a job is present in the job list 642 of the server print queue information 640. If the job is still present (YES in step S909), the control server 402 starts processing in step S902. Processing from step S902 to step S904 is similar to the description of FIG. 9A, and therefore description thereof is omitted. By controlling the number of parallel execution according to a status of print data conversion processing through the above processing, it is possible to ensure that the pull print application 303 can acquire a print data file in order of printing without delay.

As described above, by executing parallel processing while keeping a certain parallel number according to a status of processing, it is possible to control the job order and monopolization of computing resources while effectively utilizing scalability of a cloud service.

### (Description of Specific Examples)

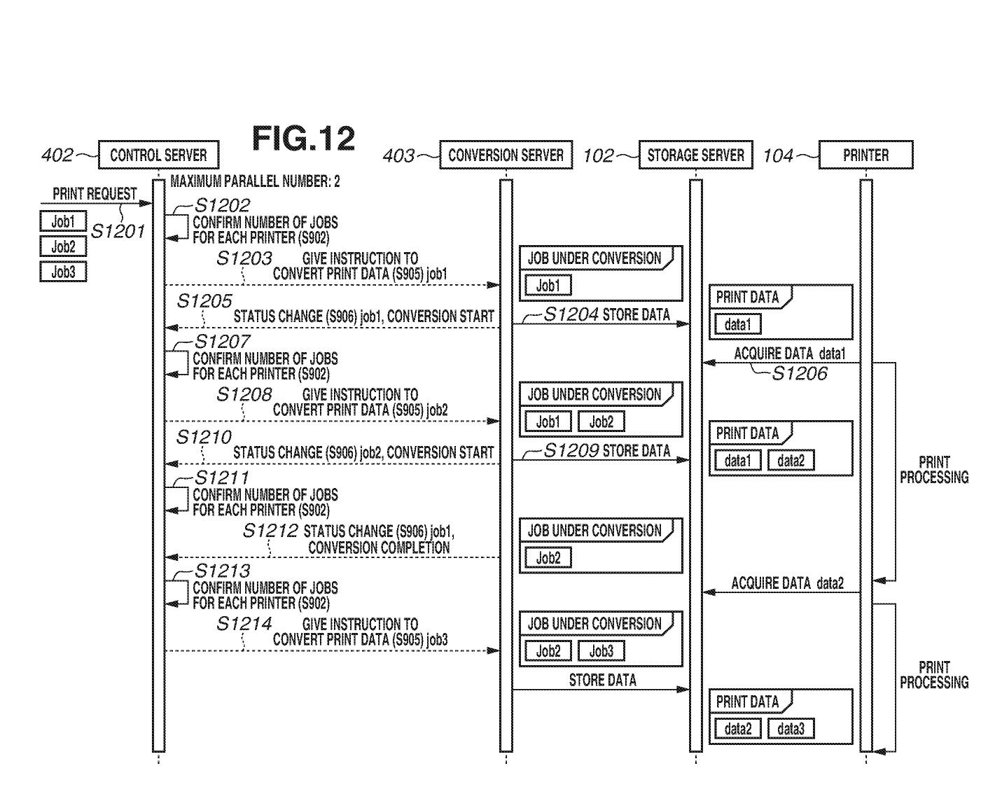

Hereinafter, a specific example of an effect on the first exemplary embodiment will be described using a processing sequence in FIG. 12. FIG. 12 is a processing sequence when a print request is received for three jobs (Job 1, Job 2, and Job 3) with respect to the printer 104. It is assumed that the three jobs are requested in order of Job 1, Job 2, and Job 3. In addition, description will be given assuming that the maximum parallel number 644 of the server print queue information 640 is “2”. In addition, it is assumed that the conversion server 403 has ability to process two jobs simultaneously at the time of starting processing in FIG. 12, and that the conversion server 403 performs auto scale and has ability to process four jobs when jobs to be processed in parallel reach two jobs. Note that the control server 402 in FIG. 12 operates according to the procedure illustrated in FIG. 9A. Therefore, steps in FIG. 9A are illustrated in parentheses.

In step S1201, the control server 402 receives the print requests (Job 1 to Job 3), and adds the print requests to the job list 642 in step S901. In step S1202, the control server 402 confirms the number of jobs under conversion with respect to the printer 104. In the example, there is no job under conversion in the conversion server 403 at this point, and therefore the control server 402 instructs the conversion server 403 to convert the print data of Job 1 in step S1203 (step S905). Here, the number of jobs to be converted by the conversion server 403 is 1.

Upon receiving the print data conversion instruction, the conversion server 403 starts conversion processing of Job 1, uploads the data (data 1) to the storage server 102 in step S1204, and performs status change notification (conversion start) of the print data conversion processing to the control server 402 in step S1205 (step S906). At this point, in step S1206, the pull print application 303 of the printer 104 starts acquisition of print data from the storage server 102, and starts print processing. At this time, the print processing of Job 1 is started in the printer 104. Therefore, the subsequent Job 2 and Job 3 do not start to be printed earlier than Job 1, and the printing order is maintained. Subsequently, in step S1207, the control server 402 confirms the number of jobs under conversion again in step S902 by receiving the status change notification of the print data conversion processing in step S1205 as described in FIG. 9B. At this point, the number of jobs under conversion in the conversion server 403 is “1” (only Job 1). Therefore, the maximum parallel number is less than 2, and the control server 402 instructs the conversion server 403 to convert print data of Job 2 in step S1208 (NO in step S903). Here, the number of jobs to be converted by the conversion server 403 is “2”. In addition, the conversion server 403 performs auto scale because the number of jobs to be converted reaches 2. In step S1209, the conversion server 403 similarly starts conversion processing of Job 2, uploads conversion data (data 2) to the storage server 102, and performs status change notification (conversion start) of the print data conversion processing of Job 2 in step S1210. Here, the print data of Job 2 is uploaded to the storage server 102. However, print processing of the printer 104 has not been completed, and therefore data acquisition by the printer 104 is not performed. Upon receiving the status change notification of the print data conversion processing in step S1210, the control server 402 confirms the number of jobs under conversion again in step S902. At this point in time, the number of jobs under conversion in the conversion server 403 is “2”, which is equal to or larger than the maximum parallel number, and the control server 402 does not give an instruction of the print data conversion processing. Here, as described above, the conversion server 403 can process two or more jobs due to the auto scale at the time of step S1208. However, by not giving an instruction of the print data conversion processing additionally, the conversion server 403 can be used without waiting for processing when another request is received. In step S1212, the conversion server 403 performs status change notification (conversion completion) of the print data conversion processing that the conversion processing of Job 1 has been completed. In step S1213, the control server 402 receives the status change notification (conversion completion) of the print data conversion processing (YES in step S907), and decreases the number of jobs under conversion by 1 in step S908. As a result, the number of jobs under conversion is less than the maximum parallel number, and therefore, in steps S909 to S905, an instruction to convert the print data of Job 3 is issued to the conversion server 403. The subsequent processing is equivalent to the above description, and therefore details thereof are omitted. In this manner, by limiting print data conversion instructions of a certain number or more, it is possible to control monopolization of the conversion server 403 while performing print data conversion processing in parallel.

Meanwhile, when the print processing in the printer 104 is completed, print data of a subsequent job (Job 2) has been already uploaded to the storage server 102 at the point of step S1209. Therefore, the pull print application 303 can start subsequent processing without delay.

As described above, according to the present exemplary embodiment, when print processing is performed using a specific printer, by suppressing the degree of parallelism (that is, the number of parallel processing) to a predetermined value, it is possible to suppress resources consumed for processing having an unnecessarily high degree of parallelism. It is thereby possible to guarantee resources allocated to other processing, and to prevent other processing from being delayed or stopped. On the other hand, it is also possible to prevent delays in print processing due to delay in job creation by permitting parallel processing of a certain degree of parallelism even for print processing using a specific printer, in particular, for generation processing of a print job.

Hereinafter, a second exemplary embodiment will be described. In the first exemplary embodiment, the method for performing parallel processing while maintaining a certain parallel number according to a status of processing has been described. However, there are cases where one document is divided into a plurality of documents for conversion processing, and a plurality of print jobs is handled as one print job. Hereinafter, a plurality of print jobs related to such one print job is referred to as a related job, and a unique identifier for associating a plurality of print jobs is referred to as a related job ID. In addition, document data divided into related jobs is referred to as divided document data. In a case of the related job, even when processing is performed in parallel, occurrence of an error in certain conversion processing in the middle may waste subsequent processing. In such a case, it is desirable to stop processing related to the related job at the time when an error occurs. Hereinafter, cancellation processing of the print server 101 in a case where an error occurs in conversion processing will be described. Note that the numbers and names in the figures are similar to those in the first exemplary embodiment unless otherwise specified.

(Related Job ID Granting Processing)

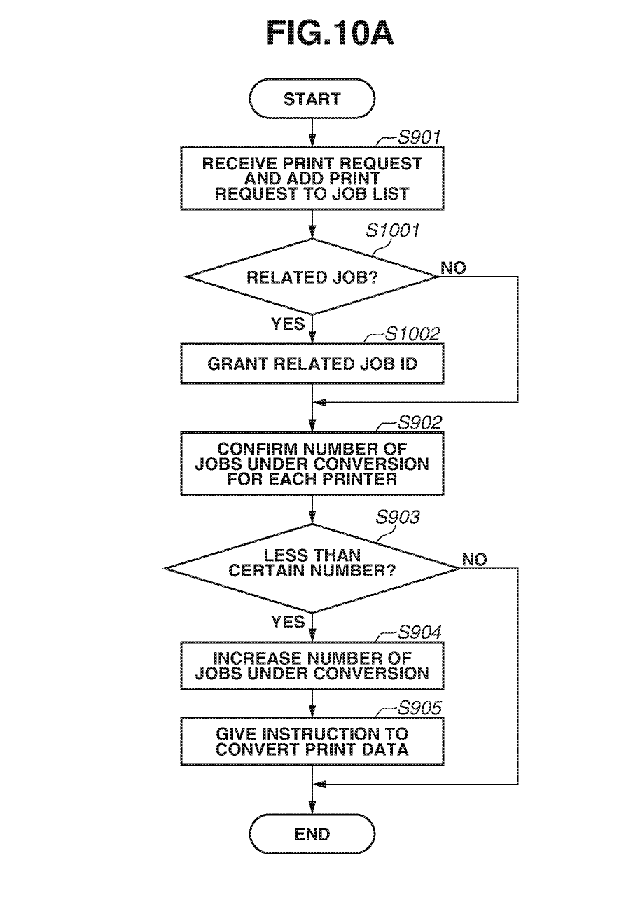

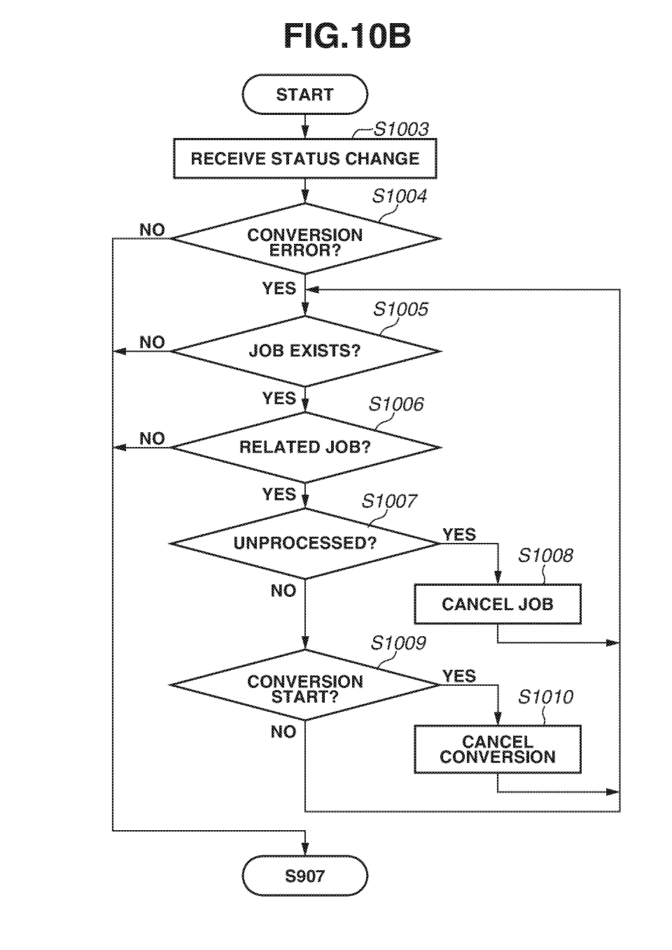

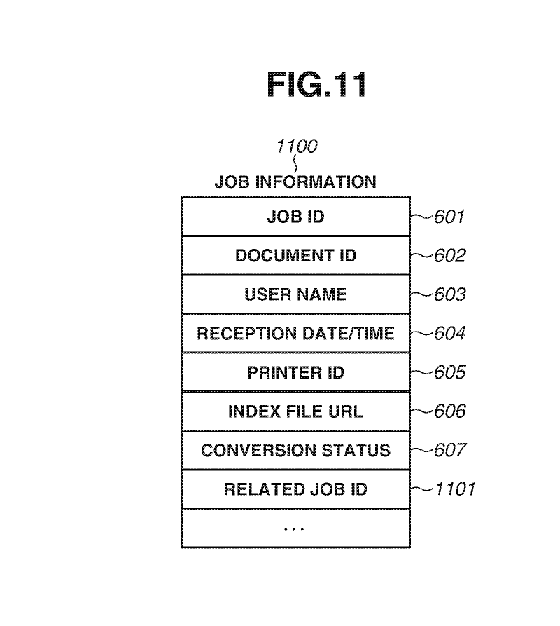

FIG. 10A is a processing flow of granting a related job ID at the time of receiving a print request of the print server 101, obtained by adding step S1001 to the processing in the first exemplary embodiment described in FIG. 9A. The procedure in FIG. 10A can be realized by executing a program stored in the RAM 222 by the CPU 220 of the print server 101, for example. Processing of steps S901 to S905 is similar to that in FIG. 9A in the first exemplary embodiment, and therefore description thereof is omitted. In step S1001, the control server 402 determines whether a print request accepted in step S901 is a related job. If the print request is a related job (YES in step S1001), the control server 402 stores a value in a related job ID 1101 of job information 1100 in step S1002. The job information 1100 in FIG. 11 is obtained by adding the related job ID 1101 to the job information 600 in the first exemplary embodiment, and the other information is similar to that in the first exemplary embodiment. Here, as a method for designating a related job from the outside, a case where a related job ID is designated for a plurality of external print requests, a case where a plurality of document IDs is designated for one print request, and the like are considered. However, the method is not particularly limited. In the present exemplary embodiment, a method is assumed in which the control server 402 handles a plurality of print jobs generated for each document ID as related jobs when a plurality of document IDs is designated for one print request, and the related job ID 1101 is issued. In addition, a value of the related job ID 1101 is only required to be unique within a system, and how to issue the value is not particularly limited.

### (Cancellation Processing of Print Data Conversion Processing)

FIG. 10B is a print job control flow at the time of receiving status change notification of the print data conversion processing, obtained by adding cancellation processing when an error occurs in the conversion processing of the related job of the print server 101. The processing in FIG. 10B is processing executed in the present exemplary embodiment in place of step S906 in FIG. 9B in the first exemplary embodiment. Note that step S907 in the present exemplary embodiment branches to step S908 also in a status of “conversion cancellation completed” in addition to the status of conversion completion and the status of conversion error. The status of “conversion cancellation completed” is a response by the conversion server 403 when cancellation is instructed for the conversion processing being executed by the data conversion unit 409, and the conversion processing is canceled accordingly. In step S1003, the control server 402 receives a status change of the print data conversion processing from the conversion server 403, and updates the conversion status 607 of the job information 1100. In step S1004, the control server 402 confirms the conversion status 607. If the conversion status 607 is a conversion error (YES in step S1004), the control server 402 confirms whether the job ID 601 is present in the job list 642 of the server print queue information 640 in step S1005. If the conversion status 607 is conversion start or conversion completion (NO in step S1004), the processing ends. In step S1006, if the job ID 601 is present in the job list 642 (YES in step S1005), the control server 402 confirms the related job ID 1101 of the job information 1100 associated with the job ID 601. In step S1007, the control server 402 confirms the conversion status 607 of the job information 1100. If the conversion status 607 is unprocessed (initial value) (YES in step S1007), the control server 402 performs job cancel processing in step S1008. Specifically, the control server 402 updates the status 625 of the document information 620, deletes the server print queue information 640 from the job list 642, and deletes the job information 1100. In step S1009, the control server 402 confirms the conversion status 607 of the job information 1100. If the conversion status 607 is conversion start (YES in step S1009), the control server 402 cancels the conversion processing in step S1010. Specifically, the control server 402 issues a conversion cancellation request for a target job with respect to the conversion server 403. Here, an operation of the conversion server 403 upon receiving the conversion cancellation request will be described (not illustrated). Upon receiving the cancellation request, the conversion server 403 deletes the document data downloaded from the storage server 102 by the conversion data management unit 408 and the data uploaded to the document URL 624 of the storage server 102. In addition, the conversion server 403 instructs the data conversion unit 409 to stop the conversion processing. In addition, the conversion server 403 returns, for example, the status of “conversion cancellation completed” to the control server 402. A response of “conversion cancellation completed” is returned for each canceled conversion processing. Due to deletion of the data in the storage server 102, the pull print application 303 inquires the control server 402 and stops the print processing. For the canceled conversion processing, the conversion server 403 makes a response of conversion cancellation completed, corresponding to the number of canceled processing, to the control server 402. In step S1004, it is determined that the status of conversion cancellation completed is not a conversion error, and branches to step S907. In step S907, the status of conversion cancellation completed also branches to step S908. The number of canceled conversion processing is thereby subtracted from the number of jobs under conversion. In step S1008, a related job has been canceled. Therefore, conversion processing is executed for a subsequent waiting print job other than the cancelled related job. A cancellation instruction for the pull print application 303 can be realized by the method described above or by describing the fact in the index file 701. Furthermore, the cancellation instruction can be also realized by a method in which the pull print application 303 periodically inquires the control server 402 and determines print stop during the print processing.

The control server 402 performs processing of steps S1005 to S1010 on all jobs in the job list.

Through the above processing, when a conversion error occurs, it is possible to stop conversion processing of a job related to a job in which the error has occurred, and it is possible to suppress useless resource consumption. In addition, parallel processing can be performed for a job not related to the job in which the error has occurred.

### Other Embodiments

Embodiments can also be realized by a computer of a system or apparatus that reads out and executes computer executable instructions recorded on a storage medium (e.g., non-transitory computer-readable storage medium) to perform the functions of one or more of the above-described embodiment(s), and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)m), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-174966, filed Sep. 7, 2016, which is hereby incorporated by reference herein in its entirety.

What is claimed is:

1. An information processing apparatus capable of executing, in parallel, a plurality of conversion processing for converting document data into print data printable by a printer, the information processing apparatus comprising:
a determination unit configured to determine whether the number of the conversion processing being executed in parallel exceeds a predetermined number for each management unit according to a received conversion request; and
a unit configured to cause conversion processing for document data related to the conversion request to be placed in a queue in a case where the determination unit determines that the number of the conversion processing exceeds the predetermined number, and to start the conversion processing for the document data related to the conversion request in a case where the determination unit determines that the number of the conversion processing does not exceed the predetermined number.

2. The information processing apparatus according to claim 1, wherein, in a case where the conversion processing being executed ends, the conversion processing in the queue is started.

3. The information processing apparatus according to claim 1,
wherein, in a case where it is indicated that the conversion request is a request related to divided document data obtained by dividing original document data, conversion processing is executed for each piece of the divided document data, and
wherein, in a case where the conversion processing being executed ends and the conversion processing is processing for the divided document data, conversion processing for other divided document data divided from the original document data of the divided document data is stopped, and the waiting conversion processing for the other divided document data is canceled.

4. The information processing apparatus according to claim 1, wherein, even in a case where the conversion processing being executed is stopped, the conversion processing in the queue is started.

5. The information processing apparatus according to claim 1, further comprising a unit configured to transmit print data generated by the conversion processing to a storage server and store the print data in the storage server.

6. The information processing apparatus according to claim 1, further comprising a unit configured to receive the conversion request from a web browser.

7. The information processing apparatus according to claim 1, further comprising a storage unit configured to store the number of the conversion processing being executed in parallel,
wherein, in a case where the conversion processing is newly started, the number of the conversion processing is increased, and in a case where the conversion processing is ended, the number of the conversion processing is decreased.

8. The information processing apparatus according to claim 1, wherein the management unit means a user unit.

9. A control method for an information processing apparatus capable of executing, in parallel, a plurality of conversion processing for converting document data into print data printable by a printer, the control method comprising:
determining whether the number of the conversion processing being executed in parallel exceeds a predetermined number for each management unit according to a received conversion request.

10. A non-transitory computer-readable storage medium storing a program of a control method for an information processing apparatus capable of executing, in parallel, a plurality of conversion processing for converting document data into print data printable by a printer, the program being configured to execute:
determining whether the number of the conversion processing being executed in parallel exceeds a predetermined number for each management unit according to a received conversion request.
